(19) United States
(12) Patent Application Publication
(10) Pub. No.: US 2015/0069024 A1
(43) Pub. Date: Mar. 12, 2015

(54) METHOD FOR GAS METAL ARC WELDING

(71) Applicants: Erwan Siewert, Munich (DE); Laurentius Dreßel, Schweitenkirchen (DE)

(72) Inventors: Erwan Siewert, Munich (DE); Laurentius Dreßel, Schweitenkirchen (DE)

(21) Appl. No.: 14/459,891

(22) Filed: Aug. 14, 2014

(30) Foreign Application Priority Data
Sep. 12, 2013 (DE) 102013015171.6

(51) Int. Cl. B23K 9/16; B23K 9/173

(52) U.S. Cl. CPC B23K 9/164; B23K 9/173
USPC 219/74

(57) ABSTRACT

A method for gas metal arc welding, as well as to a device for gas metal arc welding and the use of an additional gas during gas metal arc welding, wherein a wire electrode is melted by an arc, wherein the arc burns between the wire electrode and a work piece, and an inert gas is supplied, and wherein an additional gas in the form of at least one additional gas flow directed toward the tip of the wire electrode is supplied in addition to the inert gas.

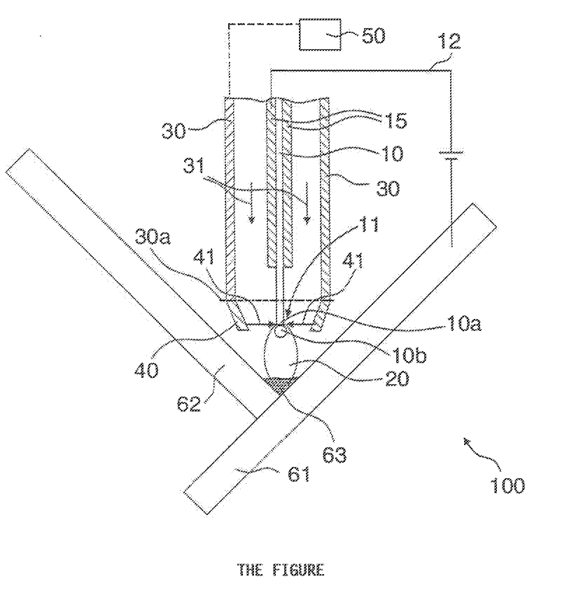

### CROSS REFERENCE TO RELATED APPLICATIONS

This application claims priority from German Patent Application DE102013015171.6 filed Sep. 12, 2013.

### BACKGROUND OF THE INVENTION

The invention relates to a method for gas metal arc welding, as well as to a device for gas metal arc welding and the use of an additional gas during gas metal arc welding, wherein a wire electrode is melted by an arc, wherein the arc burns between the wire electrode and a work piece, and an inert gas is supplied.

Gas metal arc welding (GMA welding) involves an arc welding method that is used for the overlay welding, welding or soldering of one, two or more work pieces made out of metal materials. In an inert gas atmosphere, a wire electrode is here continuously fed in the form of a wire or belt and melted by an arc that burns between the work piece and wire electrode. The work piece here serves as a second electrode. In particular, the work piece here serves as a cathode, and the wire electrode as an anode. The cathode effects here at least partially melt the work piece, and form the molten bath. The end of the wire electrode is melted, and predominantly the arc yields a molten drop. Various forces cause the drop to detach from the wire electrode, and pass over into the molten bath.

This process of melting the wire electrode, forming the drop, detaching the drop and having the drop interact with the work piece is referred to as material transfer.

Depending on the inert gas used, reference is made to metal active gas welding (MAG welding) or metal inert gas welding (MIG welding). Arc types (e.g., short, long, atomizing, rotational, impulse arcs) can be tailored to most joining tasks based on the current density, selected inert gas, wire electrode diameter and arc length. However, arc operating conditions can only be used in limited current density or wire feed ranges in such GMA welding processes. Essential characteristics that determine the transition to another arc operating condition include how the arc is applied to the wire electrode and the surface tension of the drops. The surface tension of the drops falls as the temperature of the drops and oxidation rise.

In order to reliably handle special welding tasks, e.g., those involving thin sheets and root passes, use must be made of arc types that generate a relatively cold molten bath (also referred to as cold processes) for this purpose; however, the latter are associated with a low melting deposition rate. As a result, compromises have to be made with respect to the melting deposition rate. By contrast, arc types having higher and maximum melting deposition rates are used for thick components and filler beads, which in turn are associated with a high energy input into the work piece, increased process instabilities and spatter formation. The melting deposition rate in GMA welding is very strongly coupled to the energy input into the work piece, since the wire electrode acts as the “carrier” of the arc and simultaneously as a filler material, and as such can only be varied to a very limited extent without having to also change the energy input into the work piece.

GMA welding is associated with the generation of significant emissions. On the one hand, these emissions encompass UVB radiation. On the other hand, GMA welding is associated with significant emissions in the form of dust, vapor and smoke, which can be absorbed through the respiratory system. Therefore, GMA welding is linked with a strong influence on working safety and a high health risk. Such emissions are here intensified in particular given procedural irregularities, such as short circuits and spatters.

Therefore, the object of the invention during GMA welding is to increase working safety by reducing emissions, and enable a flexible influencing of material transfer,

### SUMMARY OF THE INVENTION

This object is achieved by a method according to the invention for gas metal arc welding, a device according to the invention for gas metal arc welding, and a method of use according to the invention of an additional gas during gas metal arc welding.

In a method according to the invention, a wire electrode is melted by an arc, wherein the arc burns between the wire electrode and a work piece, and an inert gas is supplied, in particular parallel to the feed direction of the wire electrode. According to the invention, an additional gas in the form of at least one additional gas flow directed toward the tip of the wire electrode is supplied in addition to the inert gas. Advantageous embodiments may be gleaned the following description.

In one embodiment of the invention there is disclosed a method for gas metal arc welding, in which a wire electrode is melted by an arc, wherein the arc burns between the wire electrode and a work piece, and an inert gas is supplied, characterized in that an additional gas in the form of at least one additional gas flow directed toward the tip of the wire electrode is supplied in addition to the inert gas.

In another embodiment of the invention, there is disclosed a device for gas metal arc welding, which exhibits a wire electrode, a work piece, an inert gas nozzle designed to supply an inert gas, characterized in that at least one additional gas nozzle is present and designed to supply an additional gas in the form of at least one additional gas flow directed toward the tip of the wire electrode.

In yet another embodiment of the invention there is disclosed a method for the use of an additional gas during gas metal arc welding, in which a wire electrode is melted by an arc, wherein the arc burns between the wire electrode and a work piece, and an inert gas is supplied, characterized in that an additional gas in the form of at least one additional gas flow directed toward the tip of the wire electrode is used in addition to the inert gas to influence the formation and detachment of a drop of the melting wire electrode.

“Work piece” is to be understood as one or more metal elements that are machined through gas metal arc welding.

The “tip” of the wire electrode is here to be understood as the respective location of the wire electrode that is melted by the arc.

Let it be noted that when reference is made in the following description to an or the additional gas, an or the additional gas flow or an or the additional gas nozzle, the design is not to be limited to a single additional gas, a single additional gas flow or a single additional gas nozzle. Rather, these formulations are each to be understood as at least one additional gas, at least one additional gas flow or at least one additional gas nozzle.

The core of the invention involves having the additional gas act on the tip of the wire electrode in a targeted and locally limited manner. Supplying the additional gas according to the invention has a targeted effect on material transfer. Supplying the additional gas according to the invention has a targeted influence on the physical characteristics of a drop of the melted wire electrode and the adjoining plasma. A specific influence is here exerted on the formation of the drop on the wire electrode and the detachment of the drop. In particular, a surface tension and a viscosity of the drop are changed. Raising or lowering the surface tension of the drop can have a targeted affect on the volume of the drop, and hence on the size of the drop. For example, influencing the size of the drop in this way can affect the ability to bridge a gap.

Furthermore, supplying the additional gas according to the invention has an effect on the forces acting on the wire electrode drop. In particular pinch-forces are affected, especially via the placement of an arc on the wire electrode. Given a concentrated application of the arc, pinch forces act axially on the wire electrode, and counteract the detachment of the drop. An arc that envelops the drop leads to pinch forces, which are directed radially inward, and facilitate drop formation and drop detachment. In addition, a pulse of additional gas flow exerts a pressure on the drop, causing the drop to deform. Effects that counteract drop detachment, in particular surface tension and viscosity, can also be influenced in a targeted manner by the additional gas, especially by cooling the melted wire electrode via oxidation or oxidation avoidance.

Influencing the drop and material transfer makes it possible to reduce the incidence of short circuits. In particular, influencing the size of the drop and detachment of the drop from the wire electrode in a targeted manner can prevent a situation in which the drop reaches a size at which the drop contacts the work piece, a short circuit bridge comes about, and a short circuit takes place. In such cases, the short circuit bridge is explosively dissolved, which is associated with significant emissions. The invention causes drops to be specifically detached from the wire end early on, so that no such short circuit arises. As a consequence, emissions are significantly reduced during gas metal arc welding. This diminishes the burden placed on the health of a user, and increases working safety.

The method according to the invention greatly improves conventional GMA welding methods. In conventional GMA welding methods, arc operating conditions can only be used in limited current density or wire feed ranges. The invention enables an extreme expansion of the wire conveying rate at which the wire electrode is fed, and hence of the deposition rate, and ultimately of the area of application for individual arc types.

The energy input into the work piece and emissions are reduced, and the deposition rate is increased. Many welding tasks can be realized more efficiently by increasing the deposition rate and reducing the energy input into the work piece. Influencing the drop in a targeted fashion makes it possible to avoid spatters, satellite drops as well as an overheating of the drop. This also avoids expensive subsequent machining operations. Process instabilities are avoided, and process reliability is radically improved. The working safety is increased, and health risks are reduced. In particular in methods with a high deposition rate, process reliability can be increased and spatter formation can be reduced.

The additional gas is preferably guided toward one or more specific positions of the wire electrode tip in a targeted fashion in the form of the at least one additional gas flow directed toward the wire electrode tip. This specific position can be the end of the unmelted wire electrode. This is to be understood as the wire electrode end before the wire electrode is melted and passes over to the drop. Alternatively or additionally, the specific position can be the transition from this end of the wire electrode to the drop. This transition is referred to as a constricted area. Alternatively or additionally, the specific position can be the drop itself. In particular by supplying the additional gas to the constricted area, i.e., to the transition from the wire electrode end to the drop, the surface tension of the drop can be varied in a targeted manner. As a result, the detachment of the drop can be specifically delayed or accelerated.

The arc base to the wire electrode can advantageously be changed by supplying the additional gas in the form of the at least one additional gas flow directed toward the wire electrode tip. The arc base is here to be understood as the surface of the wire electrode where the arc is applied to the wire electrode. The arc base is here shifted in particular in the direction of the work piece or away from the work piece. The arc base on the wire electrode can hence be varied in a targeted manner, in particular by changing the composition of the additional gas. In this way, specific physical characteristics of individual gases as the additional gas are specifically utilized to influence the arc base, and in particular the energy density of the arc base. In particular, use is here made of the enthalpy and thermal conductivity of individual gases. For example, the arc base can be given a wider design when using argon, with its low enthalpy and thermal conductivity. The temperature of the additional gas and cooling effects associated therewith are also used in a targeted manner to influence the arc base and energy density of the arc base.

In particular, a comparatively cold additional gas makes it possible to shift the arc base in the direction of the work piece. This shifting in particular elevates the energy density of the arc base. For example, the arc base can be shifted away from the work piece by using a readily ionizing gas as the additional gas. This shifting in particular reduces the energy density, and the energy is introduced at the wire electrode tip, in particular at the wire electrode end, over a larger surface.

In addition, influencing the energy density can also affect repulsive forces at the wire electrode end that are generated by the evaporation process, These repulsive forces act against drop detachment, and can cause the drop to be deflected out of the arc axis, thus leading to short circuits and spatters.

Influencing the arc base makes it possible in particular to influence the temperature distribution of the drop and prevent the drop from overheating. As a result, for example, the temperature of the drop can be reduced, and the arc power required for a specific deposition rate can be reduced, thereby decreasing the energy input into the work piece.

The additional gas is preferably supplied in the form of at least one time-variable additional gas flow directed toward the wire electrode tip. An additional gas in the form of a time-variable additional gas flow in particular encompasses an increase, decrease and/or modulation, especially to include a periodic change, which is incremental, continuous and/or definable by a mathematical function. In particular, it is possible to change a frequency, phase, amplitude, pulse shape and/or a baseline or base flow rate of a periodically altered additional gas flow. The additional gas flow can here in particular be tailored to the progression of a welding voltage and/or a welding current.

A composition and/or quantity of the additional gas in the form of the time-variable additional gas flow are preferably varied over time. In particular, the additional gas quantity is made to pulse, and highly dynamic gas pulses are generated. The additional gas can here be supplied in a dynamic and time-variable manner until into the kilohertz range. The pulses can progress continuously in specific current and voltage phases, or also as a function of the process, e.g., based on electrical signals. Varying the composition of the additional gas makes it possible to make targeted use of the characteristics of various gases, such as thermal conductivity, enthalpy, ionization energy or density, as well as chemical reactions, such as the oxidation of the drop surface and wire electrode surface, and also the avoidance of oxidation. The quantity, in particular the flow rate, of the additional gas can be used to influence the force action or pulse of the additional gas, the intensity of gas characteristics, as well as the cooling effect of the additional gas. Preferably supplied here as the additional gas is argon, helium, hydrogen, oxygen, nitrogen, carbon dioxide, either separately or mixed together. A composition and/or quantity of the inert gas are preferably held constant over time.

In an advantageous embodiment of the invention, the method according to the invention is used for gas metal arc welding with a pulsed direct current. A drop per current pulse is detached in a controlled manner during GMA pulsed welding with a pulsed direct current. This avoids short circuits and spatters. The method according to the invention makes GMA pulse welding more effective and safer in areas with a low, average and high, as well as maximum, deposition rate, without the occurrence of short circuits and spatters. As a result, process reliability and working safety are further increased, and health risks and subsequent machining operations are avoided. The working area expansion makes it possible to join a comprehensive family of materials and expand the sheet thickness range to be joined.

In an advantageous embodiment, a carbon dioxide-containing gas is supplied to GMA pulsed welding as the inert gas. In particular, the carbon dioxide content in the inert gas here measures at least 20%. The carbon dioxide in the inert gas makes it possible to improve weld penetration and elevate process reliability. In previous conventional applications of GMA pulsed welding according to prior art, the use of carbon dioxide in the inert gas could only be realized with difficulty, and was hardly possible, if at all. The carbon dioxide in the inert gas generates a more concentrated arc base, and the surface tension is reduced. This concentrated arc base causes pinch forces to act axially on the wire electrode, and counteract drop detachment. The drop here continues to grow until it touches the molten bath, and a short circuit comes about. The drop here detaches explosively from the wire electrode, which leads to an extreme spatter formation, and significantly reduces process reliability. However, supplying the additional gas according to the invention, in particular with inert or reducing gases as the additional gas, makes it possible to influence the arc base and surface tension, so that no concentrated arc base and reduction in surface tension come about. The invention now permits GMA pulsed welding with carbon dioxide-containing gas as the inert gas, and the advantages of carbon dioxide-containing gas as the inert gas can also be utilized during GMA pulsed welding.

The invention further relates to a device for gas metal arc welding, as well as to the use of an additional gas during gas metal arc welding.

Embodiments of this device according to the invention and this application according to the invention may similarly be gleaned from the above description of the method according to the invention.

A device for gas metal arc welding according to the invention here exhibits at least one additional gas nozzle, which is designed to feed an additional gas in at least one additional gas flow directed toward a wire electrode tip. The additional gas nozzle can here have several feeds and nozzle openings, so that various positions of the wire electrode tip can be exposed to different gases and gas quantities, whether simultaneously or at various times. As already explained, these wire electrode tip positions can in particular be the end of the unmelted wire electrode, the transition from this wire electrode end to the drop, and/or the drop. Feeding the additional gas nozzle based on the stick-out of the process, i.e., the distance between the work piece and additional gas nozzle, is conceivable for automated processes, so that the flow is always directed toward the same position or positions of the wire electrode.

The at least one additional gas nozzle is advantageously designed as a nozzle ring at the end of the inert gas nozzle. As a consequence, a conventional device for GMA welding can continue to be used, and upgraded to a device according to the invention with a low structural and monetary outlay. The nozzle ring can here in particular be bolted to the end of the inert gas nozzle. This also makes it easier to perform maintenance and change out the additional gas nozzle. In particular, a time-variable additional gas flow can be supplied in a highly dynamic manner until into the kilohertz range by means of this nozzle ring. Valves, for example piezo-valves and/or solenoid valves, are best used here to enable the generation of highly dynamic gas pulses until into the kilohertz range. For example, a trigger circuit with built-in lag element can be used to synchronize the gas pulses with the welding process. The high dynamics of the additional gas flow can be mapped via CMOSens technology for mass flow meters or differential pressure measurements.

The at least one additional gas nozzle preferably exhibits radially inwardly directed boreholes and/or a radially inwardly directed slit. In this way, the additional gas can be controlled in a targeted and locally limited manner, and be fed precisely to the wire electrode tip or the specific positions of the wire electrode tip.

In an advantageous embodiment of the device according to the invention, the at least one additional gas nozzle is vertically adjustable in design. In particular, precisely one additional gas nozzle can here be present having a vertically adjustable design.

The height of this one additional nozzle is here adjusted to the specific position of the wire electrode to which the additional gas is to be fed. As a consequence, a single additional nozzle can here still be used to supply the additional gas to varying positions of the wire electrode.

In an alternative advantageous embodiment, several additional gas nozzles are secured at varying, in particular fixed heights. As a result, various gases and gas quantities can be fed to the different wire electrode positions, whether simultaneously or at different times.

### BRIEF DESCRIPTION OF THE DRAWINGS

The invention and its advantages will now be explained in more detail based on the attached drawing. The FIGURE shows a schematic view depicting an embodiment of a device according to the invention for gas metal arc welding, which is designed to implement an embodiment of a method according to the invention.

### DETAILED DESCRIPTION OF THE INVENTION

The gas metal arc welding device (GMA welding device) here schematically depicted on the FIGURE as a device for gas metal arc welding (GMA welding) is marked 100. The GMA welding device 100 is used in the joining process to weld a first work piece 61 with a second work piece 62.

The GMA welding device 100 exhibits a wire electrode 10 in the form of a wire, which is enveloped by a current contact sleeve 15. An electrical voltage is applied between the first work piece 61 and the current contact nozzle 15, denoted by reference number 12. An arc 20 is initiated via contact ignition and burns between the wire electrode 10 and first work piece 61. The high temperatures melt the tip 11 of the wire electrode 10. This results in a drop 10b of melted wire. The drop 11 finally detaches from the wire electrode 10, passes over to the molten bath 63, and forms the weld seam (joint connection between the work pieces 61 and 62). The wire 10 is here continuously fed. The formation of the drop 10b and detachment of the drop 10h from the wire electrode 10 along with the transfer into the molten bath 63 are referred to as material transfer.

The GMA welding device 100 further exhibits an inert gas nozzle 30 to provide a constant supply of inert gas in terms of quantity and composition, denoted by reference number 31. A schematically depicted additional gas nozzle 40 according to the invention is secured to one end 30a of the inert gas nozzle 30. The additional gas nozzle 40 is here in particular designed as an attachment that can be bolted to the inert gas nozzle 30. The additional gas nozzle 40 exhibits radially inwardly directed boreholes and slits. An additional gas in the form of at least one additional gas flow is supplied via the additional gas nozzle 40, denoted by reference number 41. The additional gas flow 41 is here directed toward the tip 11 of the wire electrode 10.

The additional gas flow 41 is directed in a targeted and locally limited manner toward one or more specific positions of the tip of the wire electrode 10 through the boreholes and slits in the additional gas nozzle 40. In particular, the additional gas flow 41 is here directed toward one end 10a of the unmelted wire electrode 10. The end 10a of the unmelted wire electrode 10 is here the end of the wire electrode 10 before the latter is melted and passes over to the drop 10b. Alternatively or additionally, the additional gas flow 41 is directed toward the transition from this end 10a of the unmelted wire electrode 10 to the drop 10b. Alternatively or additionally, the additional gas flow 41 is directed toward the drop 10b.

The additional gas makes it possible to specifically influence the formation and detachment of the drop 10b, and hence the material transfer. The formation, the detachment of the drop 10b, the drop size, the surface tension, the viscosity and/or the temperature of the drop 10b are influenced in a targeted manner, depending on compositions and quantities of the additional gas. The evaporation, and hence also the arc base, are influenced by way of the drop temperature.

In particular, the compositions and quantities of the additional gas are controlled by a control unit 50. The control unit 50 is designed to implement one embodiment of a method according to the invention. The control unit 50 in particular uses electrical signals to control how the quantity of additional gas or additional gas flow 41 is pulsed. The composition of the additional gas is varied so as to specifically influence characteristics, such as in particular thermal conductivity, ionization energy and/or density, along with the oxidation of the surface of the drop 11. The quantity of additional gas is altered so as to influence in a targeted fashion the intensity of these characteristics, along with the cooling and force action of the additional gas.

### REFERENCE LIST

100 Gas metal arc welding device
10 Wire electrode
10a End of the unmelted wire electrode
10b Drop
11 Wire electrode tip
12 Electrical voltage
15 Current contact sleeve
20 Arc
30 Inert gas nozzle
30a Inert gas nozzle end
31 Inert gas
40 Additional gas nozzle
41 Additional gas in the form of an additional gas flow
50 Control unit
61 First work piece
62 Second work piece
63 Molten bath

What we claim is:

1. A method for gas metal arc welding, in which a wire electrode is melted by an arc, wherein the arc burns between the wire electrode and a work piece, and an inert gas is supplied, comprising an additional gas in the form of at least one additional gas flow directed toward the tip of the wire electrode is supplied in addition to the inert gas.

2. The method according to claim 1, wherein the additional gas in the form of the at least one additional gas flow directed toward the tip of the wire electrode is supplied to one end of the unmelted wire electrode, to a transition from the end of the unmelted wire electrode to a drop of the wire electrode and/or to the drop of the wire electrode.

3. The method according to claim 1, wherein supplying the additional gas in the form of the at least one additional gas flow directed toward the tip of the wire electrode shifts an arc base on the wire electrode.

4. The method according to claim 1, wherein the additional gas is supplied in the form of at least one time-variable additional gas flow directed toward the tip of the wire electrode.

5. The method according to claim 4, wherein a composition and/or quantity of the additional gas in the form of the time-variable additional gas flow are varied over time.

6. The method according to claim 1, wherein the additional gas supplied is selected from the group consisting of argon, helium, hydrogen, oxygen, nitrogen, and carbon dioxide, either separately or mixed together.

7. The method according to claim 1, wherein a composition and/or a quantity of the supplied inert gas are held constant.

8. The method according to claim 1, wherein gas metal arc welding takes the form of gas metal arc pulsed welding with a pulsed direct current.

9. The method according to claim 8, wherein gas metal arc pulsed welding with a pulsed direct current takes place with a carbon dioxide-containing gas as the inert gas.

10. The method according to claim 9, wherein the carbon dioxide content is at least 20%.

11. A device for gas metal arc welding, which exhibits a wire electrode, a work piece, an inert gas nozzle designed to supply an inert gas, comprising at least one additional gas nozzle is present and designed to supply an additional gas in the form of at least one additional gas flow directed toward the tip of the wire electrode.

12. The device according to claim 10, wherein the at least one additional gas nozzle is designed as a nozzle ring at the end of the inert gas nozzle.

13. The device according to claim 11, wherein the at least one additional gas nozzle exhibits radially inwardly directed boreholes and/or a radially inwardly directed slit.

14. The device according to claim 11, wherein the at least one additional gas nozzle is vertically adjustable in design.

15. The device according to claim 11, exhibiting at least two additional gas nozzles secured at different heights.

16. A method for the use of an additional gas during gas metal arc welding, in which a wire electrode is melted by an arc, wherein the arc burns between the wire electrode and a work piece, and an inert gas is supplied, comprising an additional gas in the form of at least one additional gas flow directed toward the tip of the wire electrode is used in addition to the inert gas to influence the formation and detachment of a drop of the melting wire electrode.

17. The method of use of the additional gas according to claim 16 to influence the drop in terms of surface tension, viscosity, size, volume and/or oxidation.

18. The method of use of the additional gas according to claim 16 to influence the arc.

19. The method of use of the additional gas according to claim 17 to influence the arc base on the wire electrode, an energy density of the arc and/or an energy input into the work piece.
